(19) United States
(12) Patent Application Publication
(10) Pub. No.: US 2025/0364190 A1
(43) Pub. Date: Nov. 27, 2025

(54) Wall Switch Protective Cover

(71) Applicant: Frank Muegge, Sappington, MO (US)

(72) Inventor: Frank Muegge, Sappington, MO (US)

(21) Appl. No.: 18/672,529

(22) Filed: May 23, 2024

(51) Int. Cl. H01H 9/28; H01H 21/06

(52) U.S. Cl. CPC H01H 9/287; H01H 21/06

(57) ABSTRACT

A wall switch protective cover includes a panel, a guard structure, and an attachment assembly. The panel has a flat back surface and a front surface, wherein the panel includes an elongated slot therein to permit passage of a wall switch toggle through the panel. The guard structure projects out from the front surface and is designed to protect and maintain a wall switch toggle in a desired on or off position. The attachment assembly is designed to mount the panel on a wall switch cover plate.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to wall switch accessories and more particularly pertains to a new wall switch protective cover to protect and maintain a wall switch toggle in a desired on or off position.

### (2) Description of Related Art Including Information Disclosed Under 37 CFR 1.97 and 1.98

The prior art relates to wall switch accessories. The prior art, as best understood, does not disclose switch lock devices that can be configured in various shapes and is formed to cover a wall mounted electrical switch, wherein the covers include a top and bottom tab that can be secured to cover the switch wall plate with fasteners or adhesive. A receptacle is formed between the top and bottom tabs to receive the lever portion of the switch.

### BRIEF SUMMARY OF THE INVENTION

An embodiment of the disclosure meets the needs presented above in a wall switch protective cover generally comprising a panel, a guard structure, and an attachment assembly. The panel has a flat back surface and a front surface, wherein the panel includes an elongated slot therein to permit passage of a wall switch toggle through the panel. The guard structure projects out from the front surface and is designed to protect and maintain a wall switch toggle in a desired on or off position. The attachment assembly is designed to mount the panel on a wall switch cover plate.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a wall switch protective cover according to an embodiment of the disclosure.

FIG. 2 is a rear perspective view of an embodiment of the disclosure.

FIG. 3 is a front view of an embodiment of the disclosure.

FIG. 4 is a side cross-sectional view of an embodiment of the disclosure.

FIG. 5 is a view of an embodiment of the disclosure in use.

FIG. 6 is a view of an embodiment of the disclosure in use.

FIG. 7 is a perspective view of another embodiment of the disclosure.

FIG. 8 is a perspective view of the embodiment of the disclosure of FIG. 7.

FIG. 9 is a perspective view of another embodiment of the disclosure.

FIG. 10 is a side view of the embodiment of the disclosure of FIG. 9.

FIG. 11 is a perspective view of another embodiment of the disclosure.

FIG. 12 is a side view of the embodiment of the disclosure of FIG. 11.

### DETAILED DESCRIPTION OF THE INVENTION

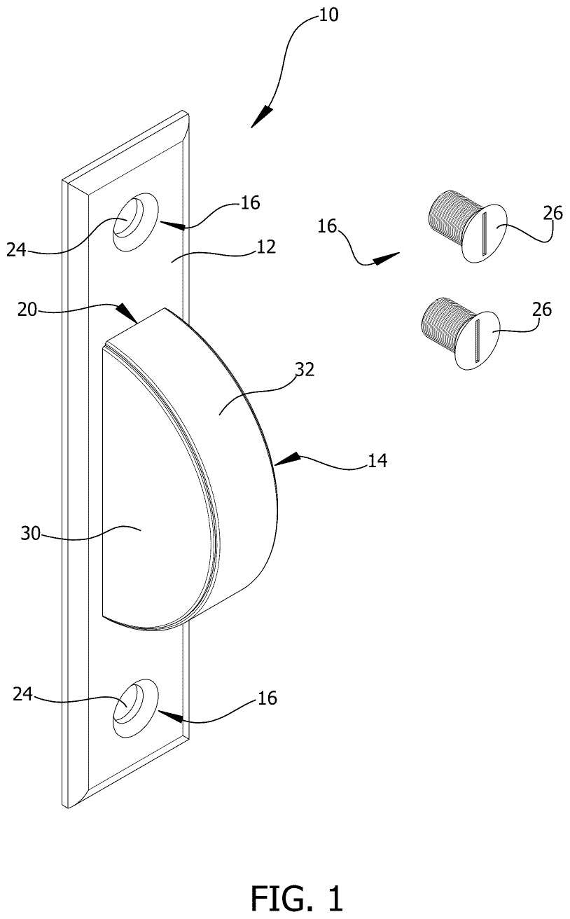

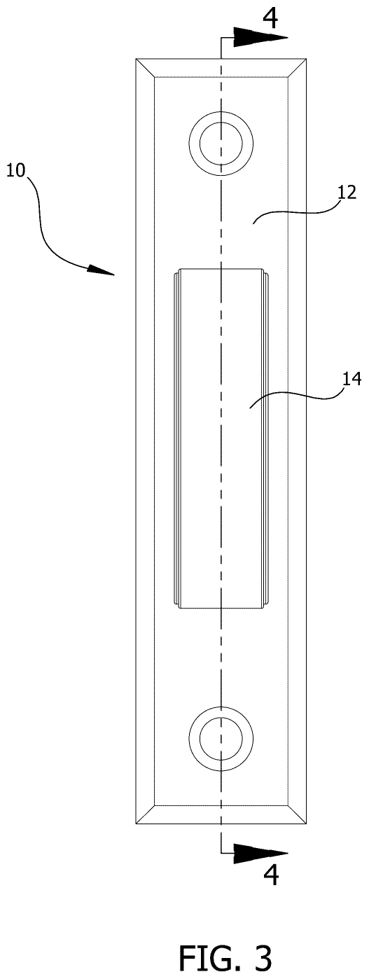

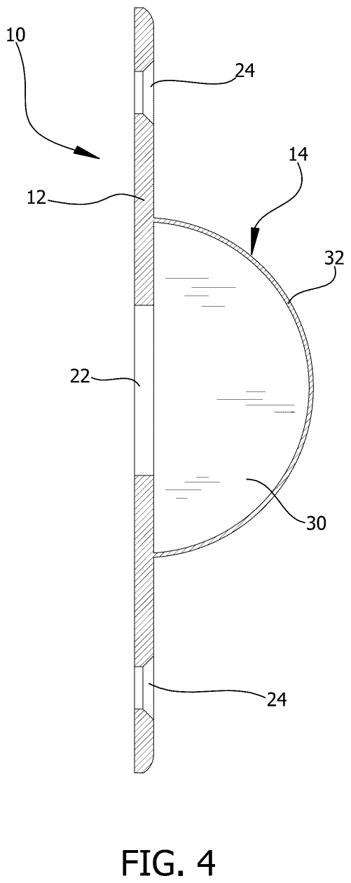

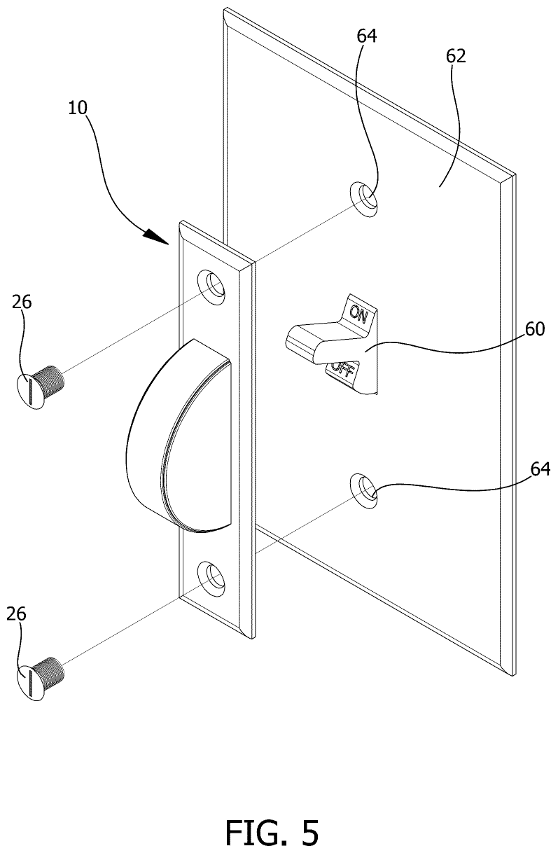

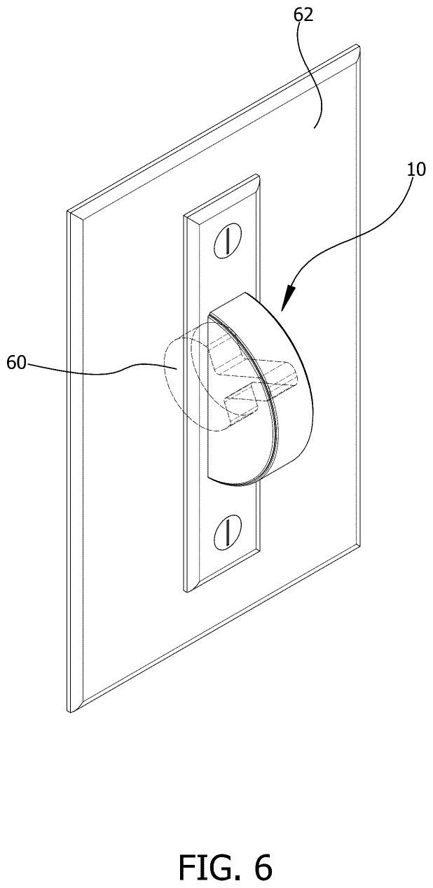

With reference now to the drawings, and in particular to FIGS. 1 through 12 thereof, a new wall switch protective cover embodying the principles and concepts of an embodiment of the disclosure and generally designated by the reference numeral 10 will be described.

As best illustrated in FIGS. 1 through 12, the wall switch protective cover 10 generally comprises a panel 12, a guard structure 14, and an attachment assembly 16. The panel 12 has a flat back surface 18 and a front surface 20, wherein the panel 12 includes an elongated slot 22 therein to permit passage of a wall switch toggle 60 through the panel 12. The guard structure 14 projects out from the front surface 20 and is designed to protect and maintain a wall switch toggle 60 in a desired on or off position. The attachment assembly 16 is designed to mount the panel 12 on a wall switch cover plate 62.

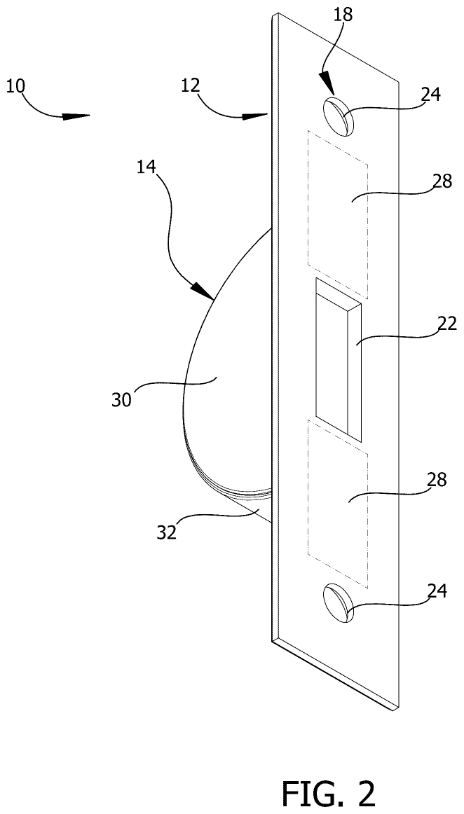

The panel 12 is in the form of an elongated strip, though other designs are possible, such as integrating the panel 12 into the wall switch cover plate 62. Each embodiment includes an attachment assembly 16. FIG. 1 shows one type of attachment assembly 16, which includes a pair of screw holes 24 positioned adjacent each end of the slot 22. These screw holes 24 are to be aligned with screw holes 64 of a wall switch cover plate 62. A pair of screws 26, which can either be part of the attachment assembly 16 as sold or be the screws 26 utilized to affix the wall switch cover plate 62, are to be inserted through the screw holes 24 to releasably attach the panel 12 to a wall switch cover plate 62. Alternatively, as shown in FIG. 2, the attachment assembly 16 could include at least one piece of adhesive material 28, such as double-sided tape or similar adhesive structures, to semi-permanently attach the panel 12 to a wall switch cover plate 62. Such a design would be useful for quick installations and when the user has no intention of ever removing the wall switch protective cover 10, or at least not for a substantial period of time. The panel 12 could include both the screw holes 24 and the adhesive material 28 to provide installation options to the user.

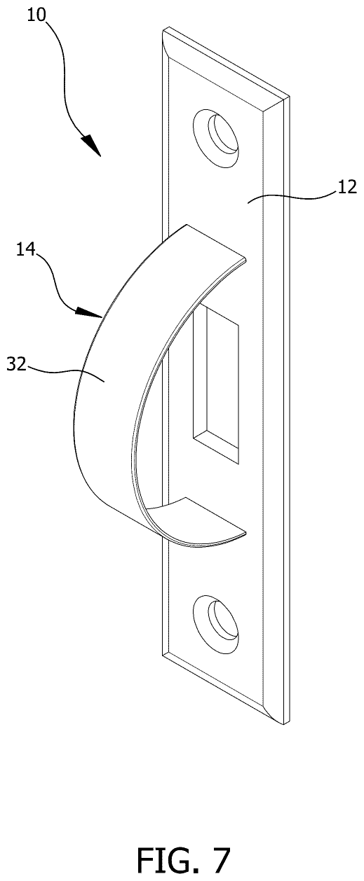

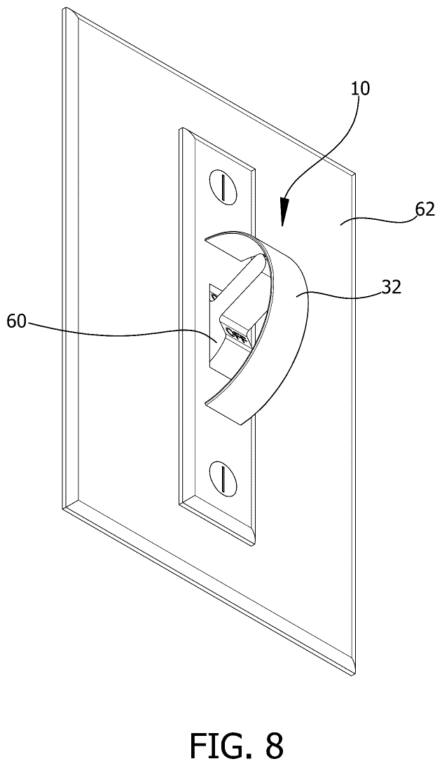

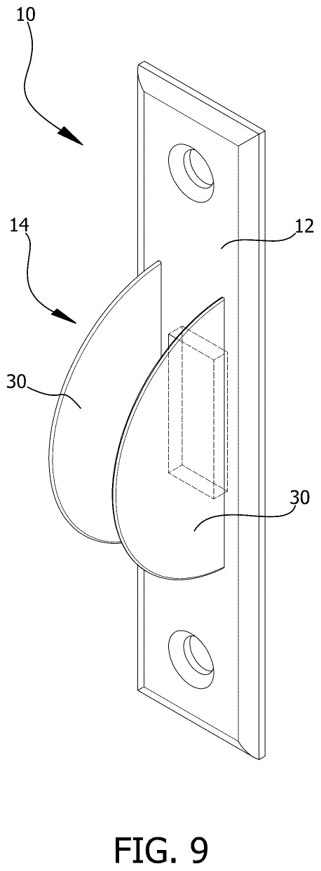

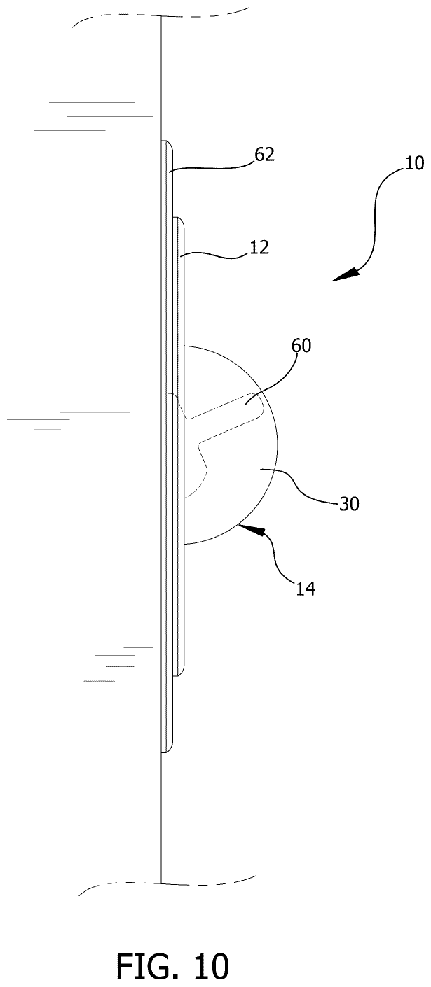

The guard structure 14 can have different designs. FIGS. 1 through 6 and 9 through 12 show embodiments in which the guard structure 14 comprises a pair of side walls 30 projecting perpendicularly out from the front surface 20 on either transverse side of the slot 22. The side walls 30 are designed to protect a wall switch toggle 60 from unintentional switching. In FIGS. 1 through 6, the side walls 30 have a semi-circular shape. In addition, the guard structure 14 includes a top wall 32 connected at and extending along the edges of the side walls 30 to completely enclose the wall switch toggle 60 when placed over the wall switch toggle 60. In this embodiment, the user selects the position of the wall switch toggle 60 and then places the wall switch protective cover 10 in place such that the guard structure 14 prevents any access to the wall switch toggle 60 to prevent unintentional switching of the wall switch toggle 60. In the embodiment in FIGS. 9 and 10, the top wall 32 is omitted and only the side walls 30 are included. The user has the option to still switch the wall switch toggle 60, but the side walls 30 protect against most accidental contact. In contrast, FIGS. 7 and 8 show an embodiment in which the side walls 30 are omitted and only the top wall 32 in the form of a curved arch is included, which also allows the option to still switch the wall switch toggle 60, but the top wall 32 protects against most accidental contact.

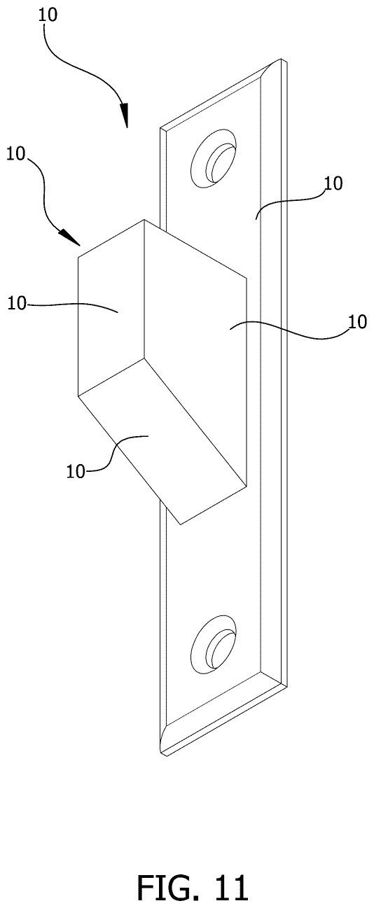

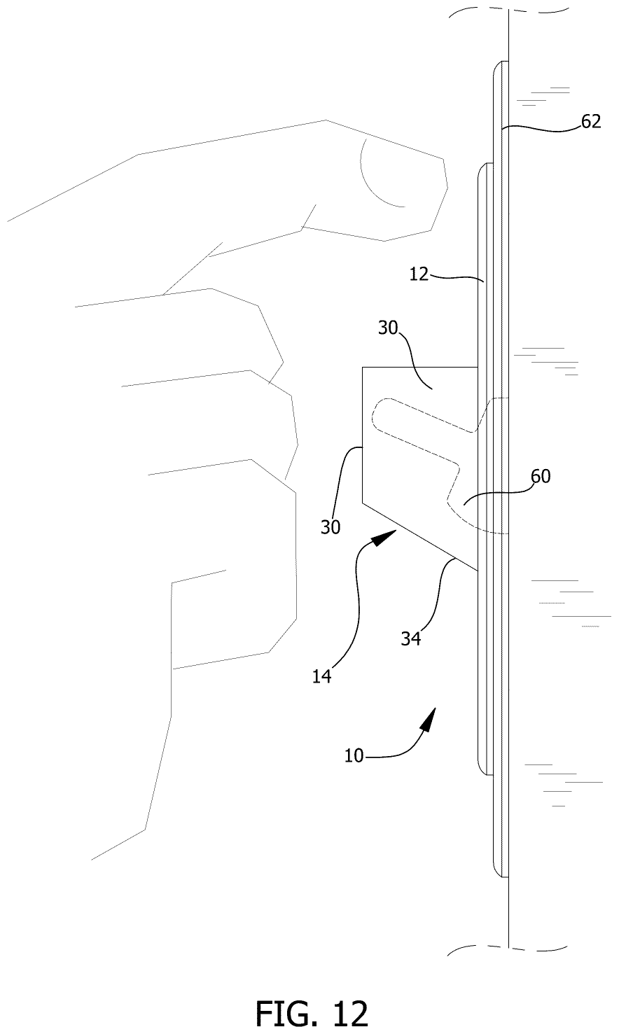

In FIGS. 1 through 10, the guard structure 14 permits the wall switch toggle 60 to be placed in either the on or off position, that is, up or down. It is therefore possible that the user could inadvertently install the wall switch protective cover 10 with the wall switch toggle 60 in the incorrect position. The embodiment in FIGS. 11 and 12 only allows one position of the wall switch toggle 60. The side walls 30 are in the shape of a right trapezoid. Accordingly, there is room inside the guard structure 14 for only one position of the wall switch toggle 60. For example, if the user installs the wall switch protective cover 10 with the angled portion 34 of the guard structure 14 on the bottom, as shown in FIG. 12, then the wall switch toggle 60 must be switched in the upward position. Alternatively, if the user installs the wall switch protective cover 10 in the opposite orientation with the angled portion 34 of the guard structure 14 on the top, then the wall switch toggle 60 must be switched in the downward position. Therefore, the position of the wall switch toggle 60 is guaranteed by the orientation of the guard structure 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wall switch protective cover comprising:
a panel having a flat back surface and a front surface, wherein said panel comprises an elongated slot therein to permit passage of a wall switch toggle through said panel;
a guard structure projecting out from said front surface and configured to protect and maintain a wall switch toggle in a desired on or off position; and
an attachment assembly configured to mount said panel on a wall switch cover plate.

2. The wall switch protective cover of claim 1, wherein said guard structure comprising a pair of side walls projecting perpendicularly out from said front surface on either transverse side of said slot and configured to protect a wall switch toggle from unintentional switching

3. The wall switch protective cover of claim 2, wherein said side walls have a semi-circular shape.

4. The wall switch protective cover of claim 3, wherein said guard structure comprises a top wall connected at and extending along the edges of said side walls to completely enclose a wall switch toggle when placed over a wall switch toggle.

5. The wall switch protective cover of claim 4, wherein said attachment assembly comprises a pair of screw holes disposed adjacent each end of said slot and to be aligned with screw holes of a wall switch cover plate and a pair of screws to be inserted through said screw holes to releasably attach said panel to a wall switch cover plate.

6. The wall switch protective cover of claim 4, wherein said attachment assembly comprises at least one piece of adhesive material to semi-permanently attach said panel to a wall switch cover plate.

7. The wall switch protective cover of claim 2, wherein said side walls are in the shape of a right trapezoid.

8. The wall switch protective cover of claim 7, wherein said guard structure comprises a top wall connected at and extending along the edges of said side walls to completely enclose a wall switch toggle when placed over a wall switch toggle.

9. The wall switch protective cover of claim 8, wherein said attachment assembly comprises a pair of screw holes disposed adjacent each end of said slot and to be aligned with screw holes of a wall switch cover plate and a pair of screws to be inserted through said screw holes to releasably attach said panel to a wall switch cover plate.

10. The wall switch protective cover of claim 8, wherein said attachment assembly comprises at least one piece of adhesive material to semi-permanently attach said panel to a wall switch cover plate.

11. The wall switch protective cover of claim 1, wherein said attachment assembly comprises a pair of screw holes disposed adjacent each end of said slot and to be aligned with screw holes of a wall switch cover plate and a pair of screws to be inserted through said screw holes to releasably attach said panel to a wall switch cover plate.

12. The wall switch protective cover of claim 1, wherein said attachment assembly comprises at least one piece of adhesive material to semi-permanently attach said panel to a wall switch cover plate.

13. The wall switch protective cover of claim 1, wherein said guard structure comprises a top wall extending over said slot from one end to the other and configured to arch over a wall switch toggle when placed over a wall switch toggle.

14. The wall switch protective cover of claim 1, wherein said panel is in the form of an elongated strip.

15. The wall switch protective cover of claim 2, wherein said panel is in the form of an elongated strip.

16. The wall switch protective cover of claim 7, wherein said panel is in the form of an elongated strip.
